(19) United States
(12) Patent Application Publication
(10) Pub. No.: US 2021/0303596 A1
(43) Pub. Date: Sep. 30, 2021

(54) DATABASE MANAGEMENT SYSTEM AND DATABASE MANAGEMENT METHOD

(71) Applicant: HITACHI, LTD., Tokyo (JP)

(72) Inventors: Naoya AKEDO, Tokyo (JP); Akira SHIMIZU, Tokyo (JP); Kenichi KAKU, Tokyo (JP)

(73) Assignee: HITACHI, LTD., Tokyo (JP)

(21) Appl. No.: 17/023,769

(22) Filed: Sep. 17, 2020

(30) Foreign Application Priority Data
Mar. 30, 2020 (JP) 2020-060554

(51) Int. Cl. G06F 16/27; G06F 16/23

(52) U.S. Cl. CPC G06F 16/273; G06F 16/2379

(57) ABSTRACT

A DBMS includes a first node and a plurality of second nodes. The first node manages a state of each second node. When a first DB of the first node is updated, the update is reflected in a second DB of each second node. The first node changes a state of each of a fixed number of the second nodes to “retrieval stop” (a retrieval TX cannot be received). When each of the fixed number of the second nodes is not executing the retrieval TX, a reference destination is defined as data in the updated second DB, and the first node changes the state of the second node to “normal” (the retrieval TX can be received). When the retrieval TX is received, the first node allocates the retrieval TX to the “normal” second node.

### CROSS-REFERENCE TO PRIOR APPLICATION

This application relates to and claims the benefit of priority from Japanese Patent Application number 2020-60554, filed on Mar. 30, 2020 the entire disclosure of which is incorporated herein by reference.

### BACKGROUND

The present invention generally relates to database management.

Towards a digital reform of a corporation, a system which analyzes a large quantity of various data generated every day and utilizes the analysis in determination of daily business has been desired. One conceivable method for analyzing such a large quantity of various data is a method of periodically registering a large quantity of data in a batch in a database management system (DBMS) and retrieving the data. A scale of such data sometimes reaches a class of several hundred millions records or a total size of the data sometimes reaches a TB (terabyte) class. Further, time needed for retrieval of such data can be several hours or several days.

In recent years, utilization of a cloud environment where computer resources can be quickly supplied is increasing. In the cloud environment, a plurality of servers can be utilized as one DBMS, in other words, a distributed system configured by a plurality of servers can be turned to a DBMS. Document 1 discloses an intermediating device. The intermediating device selects one of a plurality of database servers as a leader and others as followers in advance, transmits a processing request received from a client computer only to the leader when receiving the processing request, and transmits the processing request to the followers when receiving a response to the processing request from the leader.
Document 1: Japanese Patent Laid-Open No. 2009-169449

### SUMMARY

It is assumed that a plurality of instances (an example of a plurality of computers) includes a plurality of databases respectively, and a DBMS including a plurality of nodes respectively provided in the plurality of instances is achieved. In this case, there is a case where the DBMS cannot perform consistent retrieval. For example, the node in a certain instance receives an update transaction and updates the database (DB) of the certain instance. Update of the DB is reflected (copied) in the respective DBs in the remaining instances. However, the update of the DB is sometimes asynchronously reflected in at least one DB. In this case, depending on the node which receives a retrieval transaction, a retrieval range differs (hereinafter, a transaction is described as “TX”). That is, the retrieval range may be the DB in which the update is already reflected, or may be the DB in which the update is not reflected yet.

A DBMS includes a first node and a plurality of second nodes. The first node manages a state of each second node. When a first DB of the first node is updated, the update is reflected in the second DB of each second node. The first node changes a state of each of a fixed number of the second nodes to “retrieval stop” (a retrieval TX cannot be received). When each of the fixed number of the second nodes is not executing the retrieval TX, a reference destination is defined as data in the updated second DB, and the first node changes the state of the second node to “normal” (the retrieval TX can be received). When the first node receives the retrieval TX, the retrieval TX is allocated to the “normal” second node.

According to the present invention, a DBMS including a plurality of nodes provided respectively in a plurality of computers that include a plurality of DBs respectively and reflect update of one DB in the remaining DBs can perform consistent retrieval.

### BRIEF DESCRIPTION OF THE DRAWINGS

FIG. 1 illustrates an outline of one comparative example;

FIG. 2 illustrates an outline of an embodiment 1;

FIG. 3 illustrates a configuration of an entire system including a DBMS relating to the embodiment 1;

FIG. 4 illustrates reception and execution of a retrieval TX (retrieval transaction);

FIG. 5 illustrates a part of reception and execution of an update TX (update transaction);

FIG. 6 illustrates a part of the reception and execution of the update TX;

FIG. 7 illustrates a part of the reception and execution of the update TX;

FIG. 8 illustrates a part of the reception and execution of the update TX;

FIG. 9 illustrates a part of the reception and execution of the update TX;

FIG. 10 illustrates a part of the reception and execution of the update TX;

FIG. 11 illustrates a flow of TX management processing of an ON (original node);

FIG. 12 illustrates a flow of DB synchronization processing of the ON;

FIG. 13 illustrates a flow of CN (cache node) management processing of the ON;

FIG. 14 illustrates a flow of copy management processing of the ON;

FIG. 15 illustrates a flow of the TX management processing of a CN;

FIG. 16 illustrates a flow of the copy management processing of the CN;

FIG. 17 illustrates a flow of the DB synchronization processing of the CN;

FIG. 18 illustrates a flow of node management processing of the CN;

FIG. 19 illustrates a flow of SS (snapshot) management processing of the CN;

FIG. 20 illustrates a flow of the TX management processing of the ON relating to an embodiment 2;

FIG. 21 illustrates a configuration of a CN table relating to the embodiment 2; and

FIG. 22 illustrates a part of a flow of the DB synchronization processing of the ON relating to an embodiment 3.

### DESCRIPTION OF EMBODIMENTS

In the following description, a database is referred to as a “DB”, and a database management system is referred to as a “DBMS”. An issue source of a query to the DBMS may be a computer program (an application program for example) outside the DBMS.

In the following description, an “interface apparatus” may be one or more interface devices. The one or more interface devices may be one or more communication interface devices of a same kind (one or more NICs (Network Interface Cards) for example), or may be two or more communication interface devices of different kinds (an NIC and an HBA (Host Bus Adapter) for example).

In addition, in the following description, a “memory” is one or more memory devices, and may be typically a main storage device. At least one memory device in the memory may be a volatile memory device or may be a nonvolatile memory device.

Also, in the following description, a “permanent storage apparatus” is one or more permanent storage devices. The permanent storage device is typically a nonvolatile storage device (an auxiliary storage device for example) and is specifically an HDD (Hard Disk Drive) or an SSD (Solid State Drive), for example.

Further, in the following description, a “storage apparatus” may be at least the memory of the memory and the permanent storage apparatus.

In the following description, a “processor” is one or more processor devices. At least one processor device is typically a microprocessor device like a CPU (Central Processing Unit) but may be a processor device of another kind like a GPU (Graphics Processing Unit). At least one processor device may be a single core or multi-core. At least one processor device may be a processor-core. At least one processor device may be a processor device in a broad sense like a hardware circuit (an FPGA (Field-Programmable Gate Array) or an ASIC (Application Specific Integrated Circuit) for example) which performs a part or all of processing.

In addition, in the following description, while a function may be described with an expression of “yyy unit”, the function may be achieved by one or more computer programs being executed by a processor, or may be achieved by one or more hardware circuits (FPGAs or ASICs for example). When the function is achieved by the programs being executed by the processor, since determined processing is performed while appropriately using a storage apparatus and/or an interface apparatus or the like, the function may be at least a part of the processor. The processing described with the function as a subject may be the processing performed by the processor or the apparatus including the processor. The program may be installed from a program source. The program source may be, for example, a program distribution computer or a computer-readable recording medium (a non-temporary recording medium for example). The description of each function is an example, and a plurality of functions may be gathered into one function or one function may be divided into a plurality of functions.

Further, in the following description, in a case of describing components of the same kind without distinguishing them, a common part of a reference sign (or the reference sign) may be used, and in the case of distinguishing the components of the same kind, the reference sign (or an ID of the component) may be used.

Hereinafter, with reference to the drawings, some embodiments of the present invention will be described. Note that the present invention is not limited by the following description. In addition, relations between abbreviations used in the following description and the drawings and names are as follows.

p0 ON: original node
CN: cache node
ODB: original database
CDB: cache database
SS: snapshot

### Embodiment 1

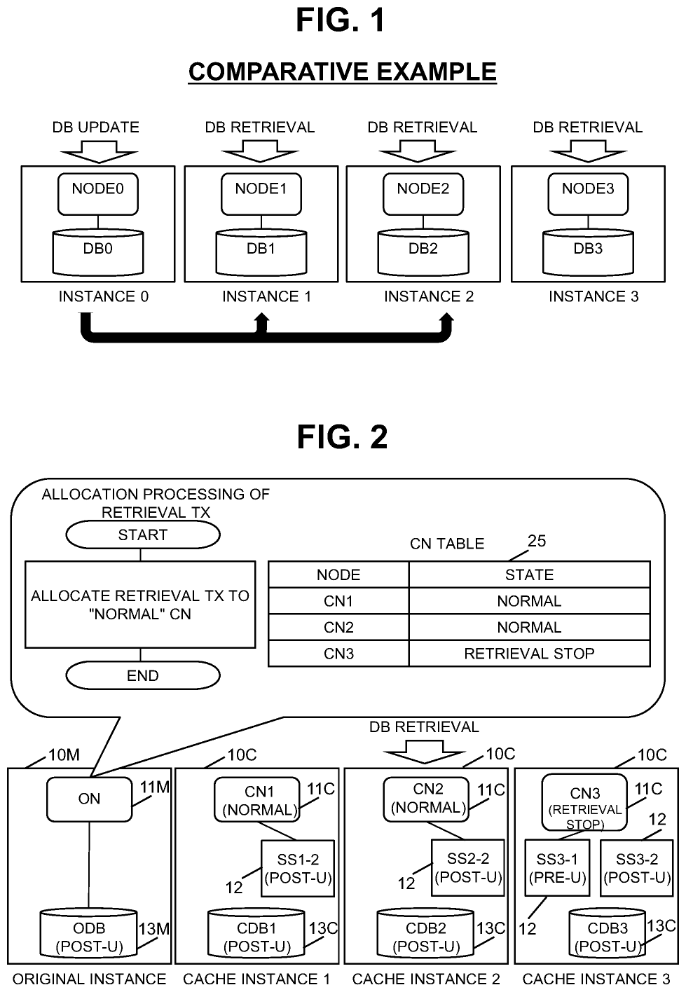

First, with reference to FIG. 1, one comparative example and problems of the comparative example will be described.

There are instances 0-3 as examples of a plurality of instances. The instances 0-3 include DBs 0-3 and nodes 0-3, respectively. When the DB 0 (an example of one DB) is updated, the update is reflected in each of the remaining DBs 1-3 (an example of a DB different from the one DB).

A first method of reflecting the update of the DB 0 in each of the DBs 1-3 is a method of utilizing backup of the DB 0 and an update log of the DB 0. However, the update of the DB 0 is sometimes reflected in each of the DBs 1-3 asynchronously with the update, and then a retrieval range differs depending on the node which receives a retrieval TX. For example, in a period during which the update of the DB 0 is reflected in each of the DBs 1 and 2 but is not reflected in the DB 3, in the case that the node 1 or 2 receives the retrieval TX, the retrieval range is the DB in which the update is already reflected, however, in the case that the node 3 receives the retrieval TX, the retrieval range is the DB in which the update is not reflected yet.

A second method of reflecting the update of the DB 0 in each of the DBs 1-3 is a method of utilizing a copy unit which performs copying between storage areas (for example, logical volumes) where the DB is stored. However, the copy unit is not linked with TX control performed by the DBMS. Therefore, consistent retrieval cannot be achieved.

Note that snapshot isolation as a technology of guaranteeing consistency of data during parallel operations is conceivable. However, just by providing a snapshot isolation function in each node, the consistent retrieval may not be achieved.

FIG. 2 illustrates an outline of the embodiment 1. Note that, in FIG. 2, “PRE-U” means it is before update, and “POST-U” means it is after update.

There are a plurality of instances 10. Each of the plurality of instances 10 includes a DB 13 and a node 11. Each node 11 can perform a database operation such as update or reference to the DB 13 in the instance 10 including the node 11, however, cannot perform the database operation to the DB 13 in the instance 10 other than the instance 10 including the node 11. Each instance 10 may be an example of a computer. The plurality of nodes 11 are components of the DBMS. In addition, in the present embodiment, each of the plurality of nodes 11 includes the copy unit to be described later, however, the copy unit may be present outside the node 11 and be one of the functions of the instance 10.

The plurality of instances 10 are an original instance 10M (an example of a first computer) and m cache instances 10C (an example of m second computers). The plurality of DBs 13 are an ODB 13M (an example of a first database) and m CDBs 13C (an example of m second databases). The plurality of nodes 11 are an ON 11M (an example of a first node) and m CNs 11C (an example of m second nodes). A value m is an integer equal to or larger than 2. In the present embodiment, it is m=3. That is, m cache instances 10C are cache instances 1-3, m CDBs 13C are CDBs 1-3, and m CNs 11C are CNs 1-3. It is assumed that, in each of m cache instances 10C, one CDB 13C is present for one ODB 13M.

The original instance 10M is the instance 10 including the ON 11M. The ON 11M is the node which receives a TX such as an update TX and a retrieval TX, executes the update TX and allocates the retrieval TX to the CN 11C. The ON 11M updates the ODB 13M by executing the update TX. The received TX may be formed of one or more CRUD (Create, Read, Update or Delete) requests, for example.

The cache instance 10C is the instance 10 including the CN 11C. The CN 11C is the node which executes the allocated retrieval TX. The CN 11C retrieves the CDB 13C inside the cache instance 10C including the CN 11C by executing the retrieval TX.

The CDB 13C is a copy of the ODB 13M. When the CN 1 of the CNs 1-3 is taken as an example, the update of the ODB 13M is reflected in the CDB 1 between the copy unit of the ON 11M and the copy unit of the CN 1. Specifically, for example, the copy unit of the ON 11M manages an update difference between the ODB 13M after the update and the ODB 13M before the update in block units for example, and transfers the update difference to the copy unit of the CN 1 in the block units for example, and the copy unit of the CN 1 reflects (writes) the update difference in the CDB 1. The update difference may not be necessarily managed and transferred in the block units.

When the CN 1 of the CNs 1-3 is taken as an example, the CN 1 (the copy unit of the CN 1 for example) generates an SS 12 of the CDB 1. At the time, the CN 1 defines the SS 12 as a reference destination. In the embodiment 1, two SS 1-1 and SS 1-2 at most are prepared for the CDB 1. A first SS 12 of a CDBx (x=1, 2 or 3) is expressed as “SSx-1” and a second SS 12 of the CDBx is expressed as “SSx-2”. For each CDB 13C, the number of SSes may be larger than 2.

In the embodiment 1, the followings are achieved in the DBMS which updates the DB using the copy unit that performs copying between the storage areas where the DB 13 is stored.
The ON 11M manages a CN table 25 (an example of management information) indicating a node state of the CN for each of the CNs 1-3. As the node state, there are “normal” (a state where the retrieval TX can be received) and “retrieval stop” (a state where the retrieval TX cannot be received).
After the update of the ODB 13M is reflected in each of the CDBs 1-3, each of the CNs 1-3 switches reference destination data of the CDB 13C in the cache instance 10C including the CN 11C. The CN 11C performing the retrieval TX before changeover of the reference destination data switches the reference destination data after the retrieval TX is ended.
When the ON 11M receives the retrieval TX after the ODB 13M is updated, the ON 11M allocates the retrieval TX to the CN 1 (or CN 2) referring to the data of the CDB 1 (or CDB 2) in which the update of the ODB 13M is reflected, in other words, the CN 1 or the CN 2 the node state of which is “normal”.

In the embodiment 1, when the ON 11M receives the update TX, the ON 11M updates the ODB 13M by executing the update TX. When the ODB 13M is updated, the following processing is performed.

(U1) When the CDB 1 of the CDBs 1-3 is taken as an example, the copy unit of the CN 1 and the copy unit of the ON 11M reflect (copy) the update difference generated by the update of the ODB 13M in the CDB 1 in the block units.

(U2) When the CN 1 of the CNs 1-3 is taken as an example, in the case that the update difference is reflected in the CDB 1, the copy unit of the CN 1 generates the SS 1-2 of the CDB 1 after the update difference is reflected.

(U3) The ON 11M changes the node states of n CNs 11C to “retrieval stop” respectively in the CN table 25. Though not illustrated, here, the n CNs 11C are the CNs 1 and 2. The n CNs 11C may be an example of a fixed number of the CNs 11C.

(U4) When the CN 1 of the CNs 1 and 2 is taken as an example, in the case that the CN 1 is not executing the retrieval TX, the CN 1 switches the reference destination of the CN 1 to the SS 1-2 generated in (U2). The ON 11M changes the node state of the CN 1 to “normal” in the CN table 25.

(U5) When the node state of each of the CNs 1 and 2 is changed to “normal”, each of (m-n) CNs 11C switches the reference destination of the CN to the SS 12 generated in (U2). An example of (m-n) CNs 11C is the CN 3. Specifically, for example, it is as follows. That is, the ON 11M changes the node state of the CN 3 to “retrieval stop” in the CN table 25. When the CN 3 is not executing the retrieval TX, the CN 3 switches the reference destination of the CN 3 to the SS 3-2 generated in (U2). The ON 11M changes the node state of the CN 3 to “normal” in the CN table 25.

In an example illustrated in FIG. 2, the reference destination of the CN 1 is the SS 1-2 of the CDB 1 in which the update is reflected, and the node state of the CN 1 is “normal”. The reference destination of the CN 2 is the SS 2-2 of the CDB 2 in which the update is reflected, and the node state of the CN 2 is “normal”. The reference destination of the CN 3 is the SS 3-1 of the CDB 3 in which the update is not reflected yet, and the node state of the CN 3 is “retrieval stop”.

During the period, when the ON 11M receives the retrieval TX, the retrieval TX is allocated to the CN 1 or the CN 2 (the CN 2 in FIG. 2) the node state of which is “normal”. The reference destination of the CN 2 the node state of which is “normal” is the SS 2-2 of the CDB 2 in which the update is reflected. Therefore, the CN 2 retrieves the SS 2-2 by executing the allocated retrieval TX.

In other words, the ON 11M does not allocate the retrieval TX to the CN 3 the node state of which is “retrieval stop”, that is, to the CN 3 the reference destination of which is the SS 3-1 of the CDB 3 in which the update is not reflected yet. In such a manner, in the present embodiment, consistent retrieval can be performed.

In addition, in the present embodiment, for each of the plurality of nodes 11 (the plurality of CNs 11C, in particular), an exclusive DB 13 (specifically, the DB 13 in the instance 10 including the node 11) is provided. In other words, the plurality of nodes 11 do not share one DB (storage apparatus). When the DB (storage apparatus) is shared, since a read performance (read throughput) is low, there is a risk that a retrieval performance declines. In the present embodiment, each CN 11C retrieves the CDB 13C exclusive for the CN 11C so that improvement of the retrieval performance can be expected.

Further, a value n of “n CNs” may be a natural number and is equal to or smaller than m. In the present embodiment, n is smaller than m. Therefore, since some CNs 11C (CNs 1 and 2 according to the example illustrated in FIG. 2) the node state of which is not “retrieval stop” are present, an allocation destination of the retrieval TX is secured.

In addition, in the present embodiment, the reference destination data of the CDB 13C is the SS 12 of the CDB 13C. By using the SS 12, service stop time of the cache instance due to reflection of the update of the ODB 13M in the CDB 13C or reference destination changeover can be shortened.

Also, in the present embodiment, the ON 11M executes the update TX but does not execute the retrieval TX. Thus, the improvement of the retrieval performance can be expected. Specifically, for example, the storage apparatus which stores the ODB 13M may be the storage apparatus for which nonvolatility of the data is guaranteed but an I/O performance is relatively low, and the storage apparatus which stores the CDB 13C may be the storage apparatus for which the nonvolatility of the data does not need to be guaranteed and the I/O performance is relatively high since the CDB 13C can be restored from the ODB 13M.

Hereinafter, the present embodiment will be described in detail. Note that both update TX and retrieval TX are received by the ON 11M in the present embodiment, but may be received by each of the CNs 1-3. In this case, in the case of receiving the update TX, each of the CNs 1-3 may transfer the update TX to the ON 11M. In addition, in the case of receiving the retrieval TX, each of the CNs 1-3 may execute the retrieval TX when the node state of the CN is “normal”. In the case of receiving the retrieval TX, each of the CNs 1-3 does not execute the retrieval TX when the node state of the CN is “retrieval stop”, and may execute at least one of (a) standing by for execution of the retrieval TX until the node state is changed to “normal”, (b) returning reception impossibility to the retrieval TX, and (c) transferring the retrieval TX to the ON 11M, for example.

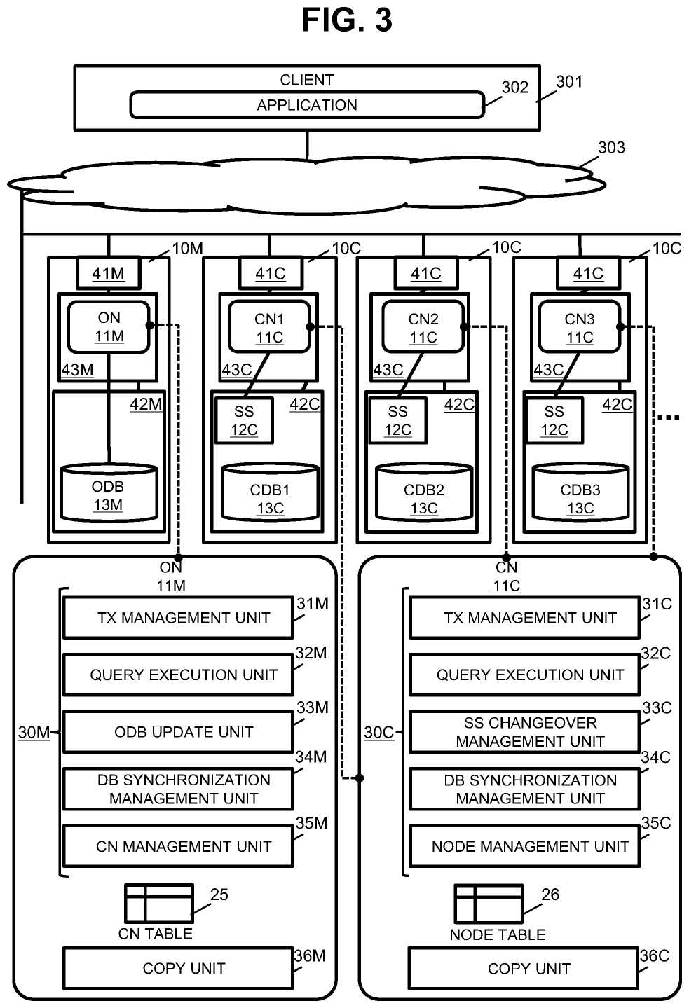

FIG. 3 illustrates a configuration of the entire system including the DBMS relating to the embodiment 1.

The original instance 10M and m cache instances 10C may be a plurality of computers in a cloud environment for example. The instances 10 are coupled to a network 303. Through the network 303, the ON 11M receives the retrieval TX and the update TX from an application 302 executed in a client 301 (typically a computer).

The original instance 10M includes an interface apparatus 41M, a storage apparatus 42M, and a processor 43M coupled to the apparatuses. The interface apparatus 41M is coupled to the network 303. The storage apparatus 42M stores the ODB 13M. The processor 43M executes the ON 11M. The ON 11M includes a DB management unit 30M that manages the ODB 13M, and a copy unit 36M that performs copying between the storage areas. The DB management unit 30M includes a TX management unit 31M that manages the TX, a query execution unit 32M that executes a query in the TX, an ODB update unit 33M that updates the ODB 13M, a DB synchronization management unit 34M that performs DB synchronization processing of the ODB 13M, and a CN management unit 35M that manages the CN 11C. The ON 11M manages the CN table 25. The CN table 25 may be stored in the storage apparatus 42M.

The cache instance 10C includes an interface apparatus 41C, a storage apparatus 42C, and a processor 43C coupled to the apparatuses. The interface apparatus 41C is coupled to the network 303. The storage apparatus 42C stores the CDB 13C. The processor 43C executes the CN 11C. The CN 11C includes a DB management unit 30C that manages the CDB 13C, and a copy unit 36C that performs copying between the storage areas. The DB management unit 30C includes a TX management unit 31C that manages the TX, a query execution unit 32C that executes a query in the TX, an SS changeover management unit 33C that switches the SS, a DB synchronization management unit 34C that performs DB synchronization processing of the CDB 13C, and a node management unit 35C that manages the CN 11C. The CN 11C manages a node table 26 that indicates the state of the CN 11C. The node table 26 may be stored in the storage apparatus 42C.

An assembly of the node tables 26 in each of the CNs 1-3 corresponds to the CN table 25. The CN table 25 and the respective node tables 26 are managed to be consistent. That is, when either the CN table 25 or any of the node tables 26 is updated, the update is reflected in the other table.

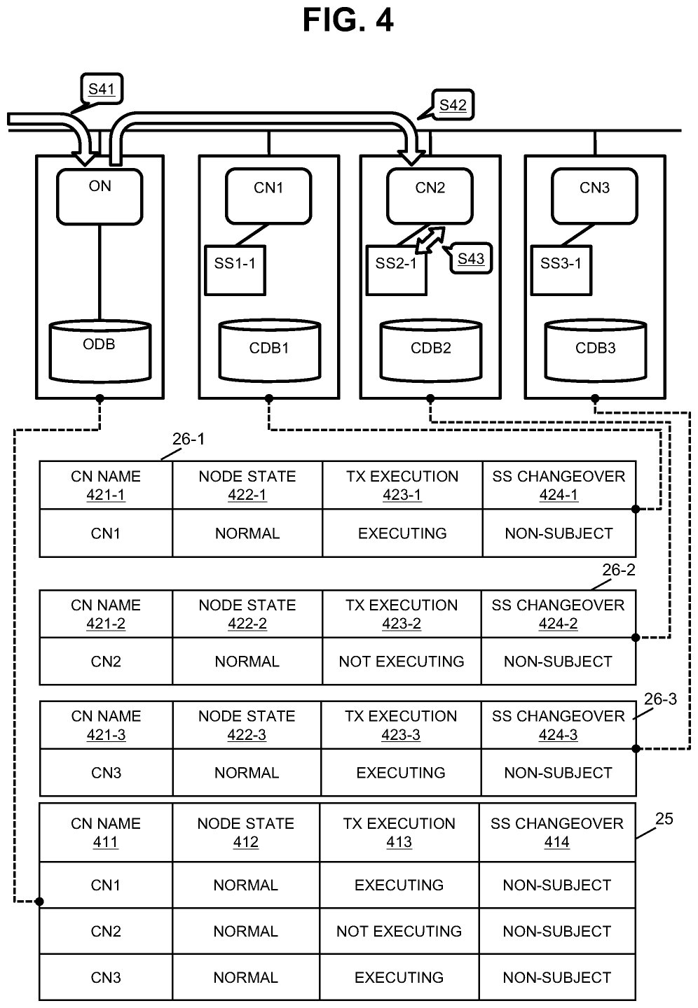

With reference to FIG. 4 to FIG. 10, examples of the processing performed in the present embodiment will be described. Note that, in the drawings, an end of the node table or the component of the CNx (x=1, 2 or 3) includes “−x”. In addition, in order to simplify the description of FIG. 4 to FIG. 10, it is assumed that m CNs 11C are CNs 1-3, and the reference sign is omitted for the ON and the ODB.

FIG. 4 illustrates reception and execution of the retrieval TX.

Among the CNs 1-3, the CN 1 is taken as an example. A node table 26-1 holds information such as a CN name 421-1, a node state 422-1, TX execution 423-1 and SS changeover 424-1. The CN name 421-1 indicates a name “CN1” of the CN 1. The node state 422-1 indicates the state of the CN 1. The TX execution 423-1 indicates whether the CN 1 is executing (“executing”) or is not executing (“not executing”) the retrieval TX. The SS changeover 424-1 indicates whether the SS of the reference destination should be switched (“subject”) or not (“non-subject”).

The CN table 25 is an assembly of the node table 26-1 to a node table 26-3. Specifically, the CN table 25 includes records for each of the CNs 1-3. Each record holds information such as a CN name 411, a node state 412, TX execution 413 and SS changeover 414. For each of the CNs 1-3, pieces of information 411-414 are same as pieces of information 421-424 for the CN.

The ON receives the retrieval TX from the application 302 (see FIG. 3) (S41). The ON refers to the CN table 25, and allocates the retrieval TX to the “normal” CN 2 (S42). The CN 2 executes the allocated retrieval TX (S43).

Note that, since the node state 412 of the CN 1 and the CN 3 is also “normal”, the allocation destination of the retrieval TX may be the CN 1 or the CN 3 instead of the CN 2. However, in the example illustrated in FIG. 4, the ON preferentially selects the CN 2 the TX execution 413 of which is “not executing” as the allocation destination of the retrieval TX. Thus, concentration of retrieval loads on any of the CNs 1-3 can be avoided.

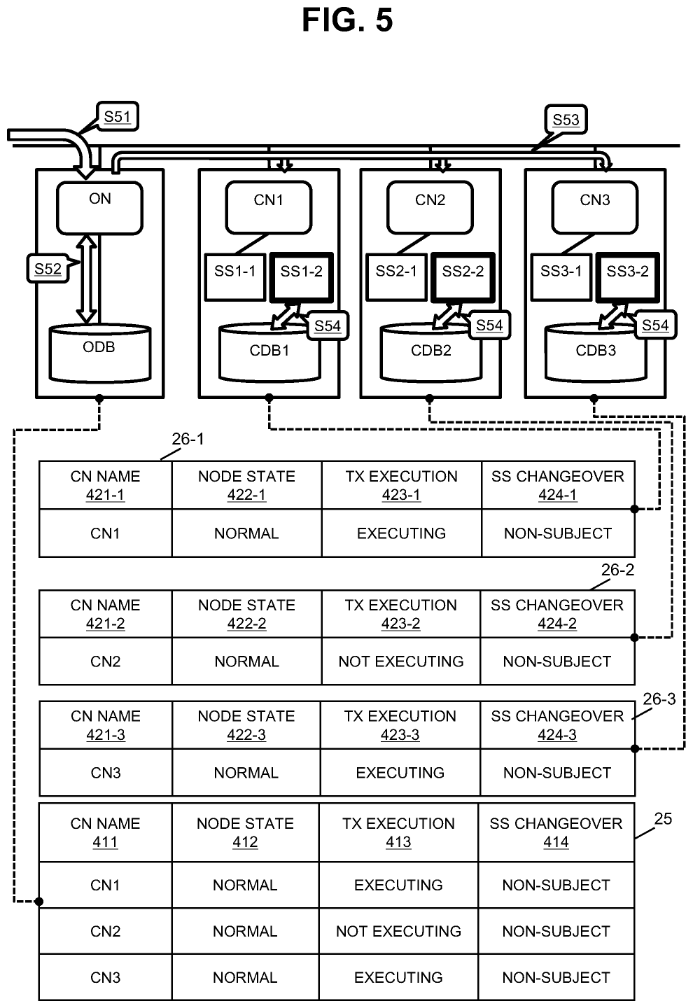

FIG. 5 to FIG. 10 illustrate reception and execution of the update TX.

As illustrated in FIG. 5, the ON receives the update TX from the application 302 (S51). The ON updates the ODB by executing the update TX (S52). The ON reflects (copies) the update difference of the ODB in each of the CDBs 1-3 in block units for example (S53). The CNs 1-3 newly generate the SSes 1-2, 2-2 and 3-2 respectively corresponding to the CDBs 1-3 in which the update is reflected, respectively (S54). Note that, in the present embodiment, the copy unit 36M (see FIG. 3) of the ON is constantly in an offline state, but may be constantly in an online state.

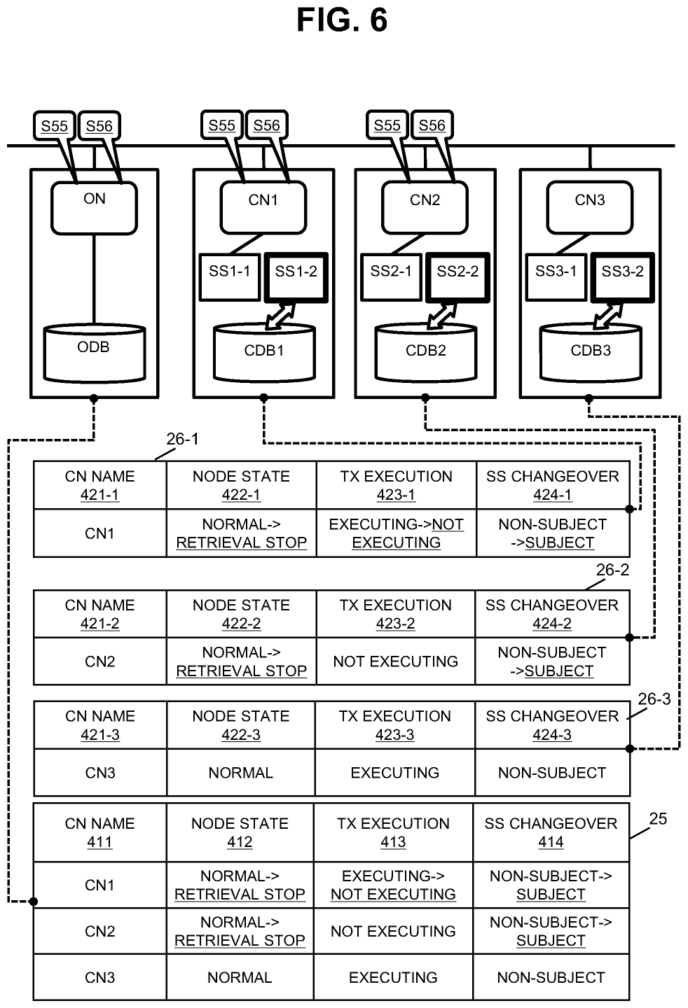

As illustrated in FIG. 6, the ON changes the node state 412 of n CNs (in the example illustrated in FIG. 6, the CNs 1 and 2) to “retrieval stop”, and changes the SS changeover 414 to “subject” (S55) in the CN table 25. As a result, each of the node states 422-1 and 422-2 is also changed to “retrieval stop”, and each of the SS changeovers 424-1 and 424-2 is also changed to “subject”.

The ON stands by until all the retrieval TXes received by the CN are settled, for each of the CNs 1 and 2 the node state 412 of which is changed to “retrieval stop” (S56). For example, when the CN 1 settles all the retrieval TXes, the value of the TX execution 423-1 is changed to “not executing”. As a result, the TX execution 413 of the CN 1 is also changed to “not executing”. When the TX execution 413 of each of the CNs 1 and 2 is “not executing”, the ON recognizes that the all the retrieval TXes received by the CN are settled for each of the CNs 1 and 2. Note that, for the CN the node state 412 of which is changed to “retrieval stop”, when there are unsettled retrieval TXes, all the retrieval TXes may be discontinued.

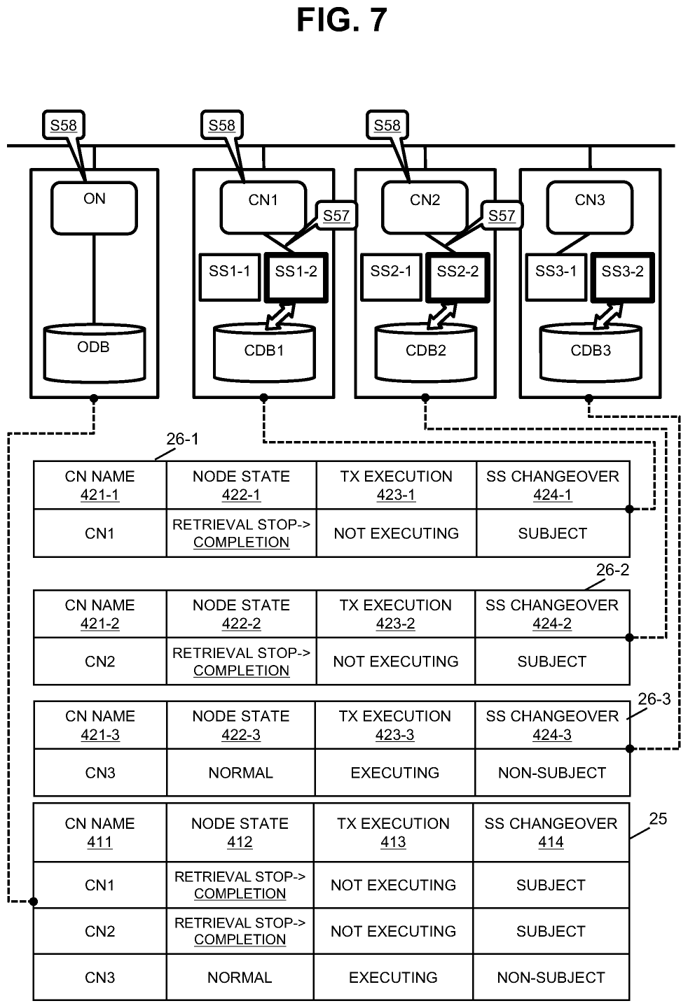

As illustrated in FIG. 7, when the CN 1 of the CNs 1 and 2 is taken as an example, when the TX execution 423-1 becomes “not executing”, the CN 1 switches the SS of the reference destination to the SS 1-2 (the latest SS) generated in S54 (S57), and changes the node state 422-1 to “completion” (the state meaning the completion of reference destination changeover) (S58). As a result, the node state 412 of each of the CNs 1 and 2 is also changed to “completion”.

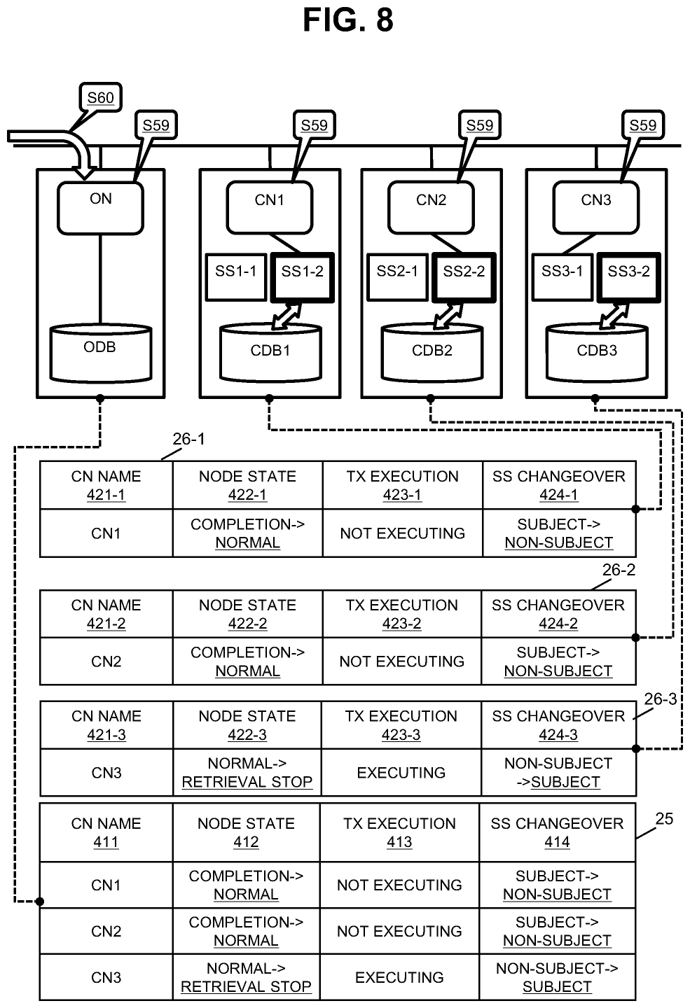

As illustrated in FIG. 8, when the node state 412 of the CNs 1 and 2 the SS changeover 414 of which is “subject” is all changed to “completion”, the ON changes the node state 412 to “normal” and changes the SS changeover 414 to “non-subject” for each of the CNs 1 and 2, and changes the node state 412 to “retrieval stop” and changes the SS changeover 414 to “subject” for the remaining CN 3 (an example of (m-n) CNs) (S59). As a result, the node states 422-1 and 422-2 are changed to “normal”, and the SS changeovers 424-1 and 424-2 are changed to “non-subject”. In addition, the node state 422-3 is changed to “retrieval stop”, and the SS changeover 424-3 is changed to “subject”.

In this way, when the node state 412 of the fixed number or more of the CNs (for example, all of n CNs) among n CNs the SS changeover 414 of which is “subject” is changed to “completion”, the ON changes the node state 412 of all the CNs the node state 412 of which is “completion” to “normal”. Thus, since there are the fixed number of the CNs for which the reference destination is changed to the new SS, retrieval performance decline immediately after the SS changeover can be prevented.

After S59, the ON settles the update TX received in S51 (S60). Note that the update TX may be settled when S52 is ended.

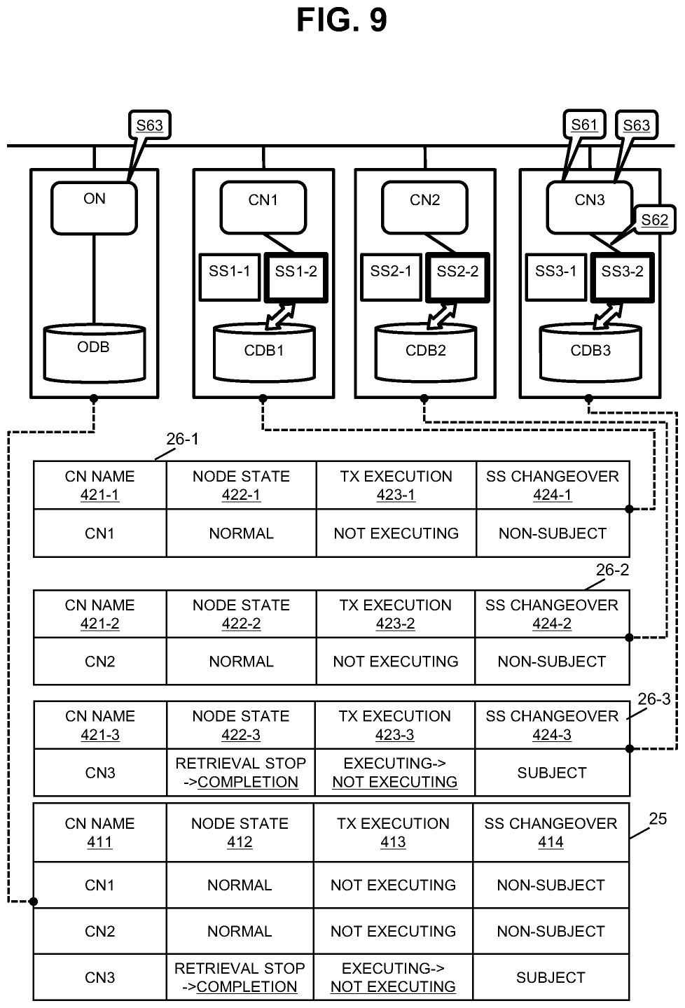

As illustrated in FIG. 9, the CN 3 the node state 422-3 of which is changed to “retrieval stop” stands by until all the retrieval TXes received by the CN 3 are settled (S61). As a result, when the TX execution 423-3 becomes “not executing”, the CN 3 switches the reference destination to the latest SS 3-2 (S62). The CN 3 changes the node state 422-3 to “completion” (S63). As a result, the node state 412 of the CN 3 is changed to “completion”.

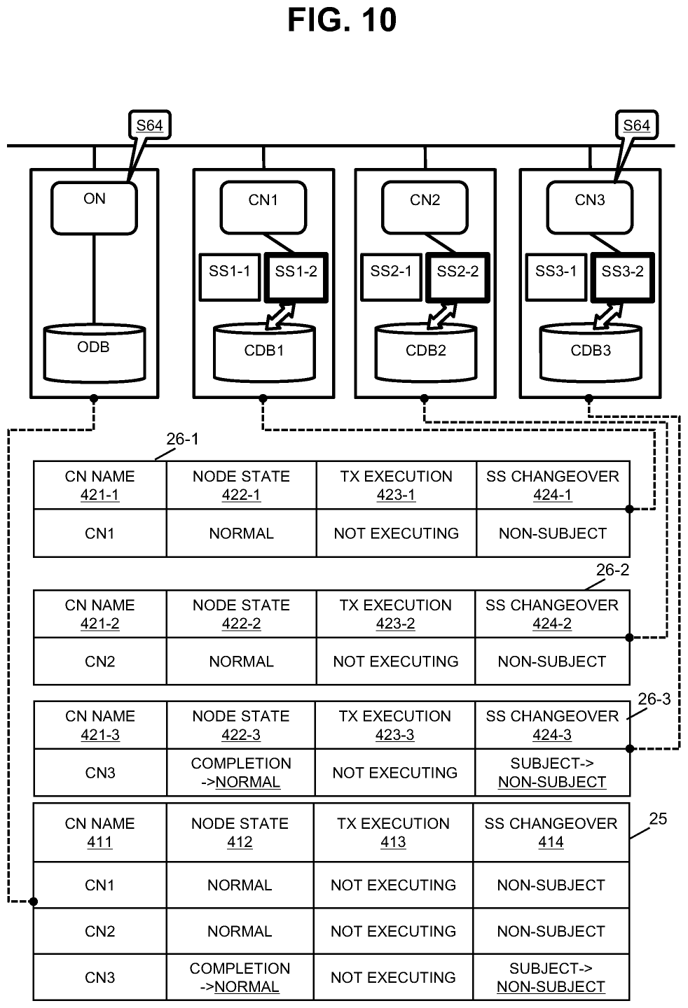

As illustrated in FIG. 10, when the node state 412 of the CN the SS changeover 414 of which is “subject” is changed to “completion”, the ON changes the node state 412 of the CN 3 to “normal”, and changes the SS changeover 414 to “non-subject” (S64).

In such a manner, also for (m-n) CNs, after the node state 412 is turned to “retrieval stop”, the SS of the reference destination is switched, the node state 412 is changed to “normal” thereafter, and thus the consistency of retrieval can be maintained.

The above S51-S64 are executed for every update TX. The update TX is, in the present embodiment, the update TX for batch registration (registration of a plurality of records in the ODB in a batch).

Hereinafter, details of the function of the ON 11M and the function of the CN 11C will be described.

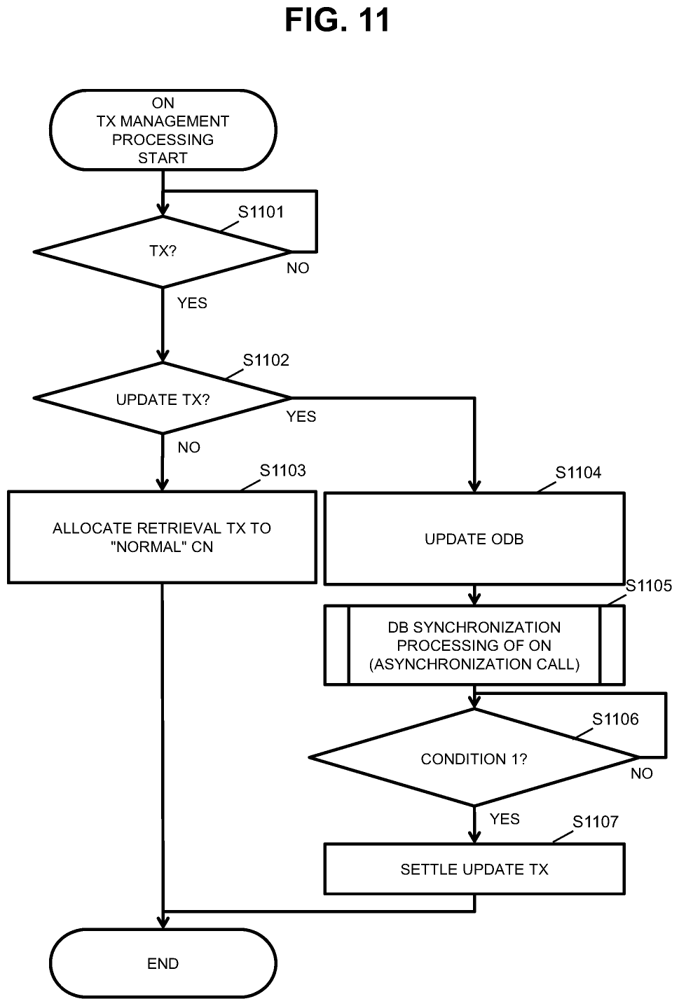

FIG. 11 illustrates a flow of TX management processing of the ON 11M.

In the case of receiving the TX (S1101: YES), the TX management unit 31M determines whether or not the TX is the update TX (S1102).

In the case that a determination result in S1102 is false (S1102: NO), the TX management unit 31M allocates the retrieval TX to the CN 11C the node state 412 of which is “normal” (S1103). Note that, in S1103, when the node state 412 of two or more CNs 11C is “normal”, the TX management unit 31M preferentially selects the CN 11C the TX execution 413 of which is “not executing” from the two or more CNs 11C, and allocates the retrieval TX to the selected CN 11C.

In the case that the determination result in S1102 is true (S1102: YES), the query execution unit 32M executes the update TX, and based on the result of the execution, the ODB update unit 33M updates the ODB 13M (S1104). Thereafter, the DB synchronization processing of the ON 11M by asynchronization call is performed (S1105). There is no need to wait for the end of the DB synchronization processing. When a condition 1 (the node state 412 of the fixed number of the CNs 11C among n CNs 11C the SS changeover 414 of which is “subject” is “completion”) is satisfied in the DB synchronization processing (S1106: YES), the TX management unit 31M settles the update TX (S1107). Settlement of the update TX is typically a commitment of the update TX.

In FIG. 11, S1102: NO corresponds to S41 in FIGS. 4, and S1103 corresponds to S42 in FIG. 4. On the other hand, S1102: YES corresponds to S51 in FIG. 5, S1104 corresponds to S52 in FIGS. 5, and S1107 corresponds to S60 in FIG. 8.

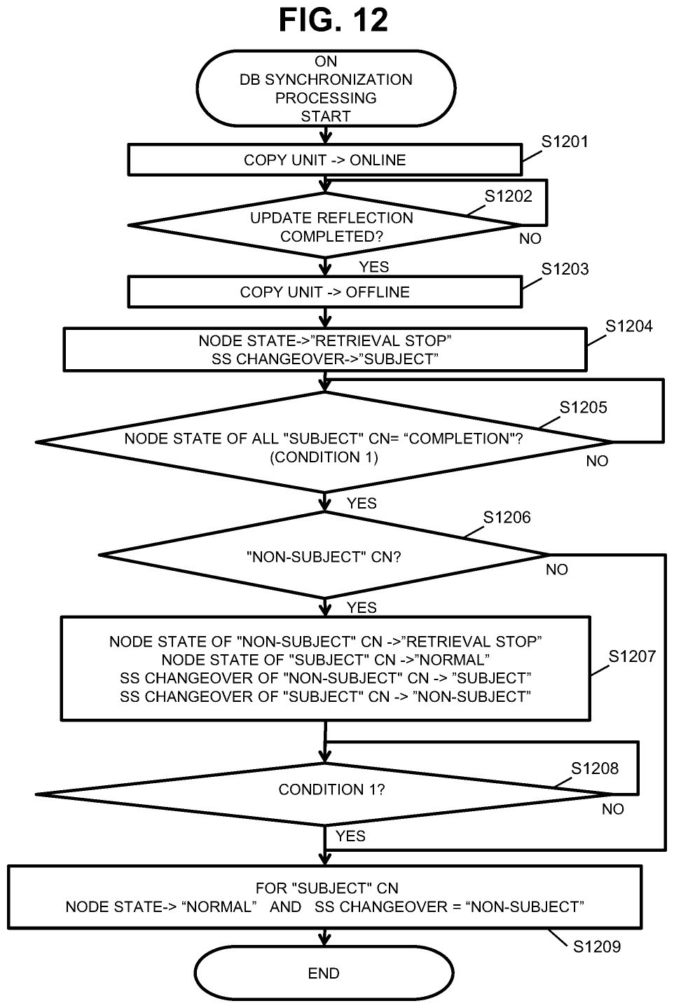

FIG. 12 illustrates a flow of the DB synchronization processing of the ON 11M.

The DB synchronization management unit 34M changes the state of the copy unit 36M to the online state (S1201). Thus, copy management processing (FIG. 14) is performed by the copy unit 36M. When update reflection (the reflection of the update difference in each CDB) is completed (S1202: YES), the DB synchronization management unit 34M turns back the state of the copy unit 36M to the offline state (S1203).

After S1203, the DB synchronization management unit 34M determines n CNs 11C, and for each of the n CNs 11C, changes the node state 412 to “retrieval stop”, and changes the SS changeover 414 to “subject” (S1204). The “n CNs 11C” may be determined according to a predetermined rule. For example, the “n CNs 11C” may be all the CNs 11C, may be a half of the CNs 11C, or may be all the CNs 11C the TX execution 413 of which is “not executing”.

The DB synchronization management unit 34M determines whether or not the condition 1 (the node state 412 of the fixed number of the CNs 11C among n CNs 11C the SS changeover 414 of which is “subject” is “completion”) is satisfied (S1205).

In the case that the determination result in S1205 is true (S1205: YES), the DB synchronization management unit 34M determines whether or not there is the CN 11C the SS changeover 414 of which is “non-subject” (S1206). In the case that the determination result in S1206 is false (S1206: NO), S1207 and S1208 are skipped and S1209 is performed.

In the case that the determination result in S1206 is true (S1206: YES), the DB synchronization management unit 34M performs the followings (S1207).
Changing the node state 412 of the CN 11C the SS changeover 414 of which is “non-subject” to “retrieval stop”.
Changing the node state 412 of the CN 11C the SS changeover 414 of which is “subject” to “normal”.
Changing the SS changeover 414 of the CN 11C the SS changeover 414 of which is “non-subject” to “subject”.
Changing the SS changeover 414 of the CN 11C the SS changeover 414 of which is “subject” to “non-subject”.

After S1207, the DB synchronization management unit 34M determines whether or not the condition 1 is satisfied (S1208).

In the case that the determination result in S1208 is true (S1208: YES) or in the case that the determination in S1206 is false (S1206: NO), for the CN 11C the SS changeover 414 of which is “subject”, the node state 412 is changed to “normal” and the SS changeover 414 is changed to “non-subject” (S1209).

In FIG. 12, S1202 corresponds to S53 in FIG. 5, S1204 corresponds to S55 in FIG. 6, S1207 corresponds to S59 in FIGS. 8, and S1209 corresponds to S64 in FIG. 10.

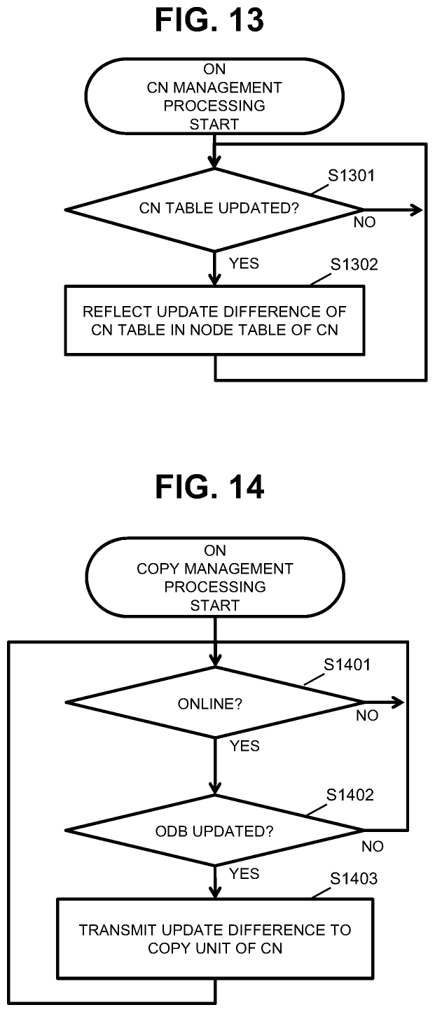

FIG. 13 illustrates a flow of CN management processing of the ON 11M.

When the CN table 25 is updated (S1301: YES), the CN management unit 35M reflects (copies) the update difference of the CN table 25 in the node table 26 of the CN 11C belonging to the update difference (S1302).

FIG. 14 illustrates a flow of the copy management processing of the ON 11M.

In the case of being in the online state (S1401: YES), the copy unit 36M determines whether or not there is the update difference of the ODB 13M (S1402). In the case that the determination result in S1402 is true (S1402: YES), the copy unit 36M transmits the update difference to the copy unit 36C of each CN 11C (S1403).

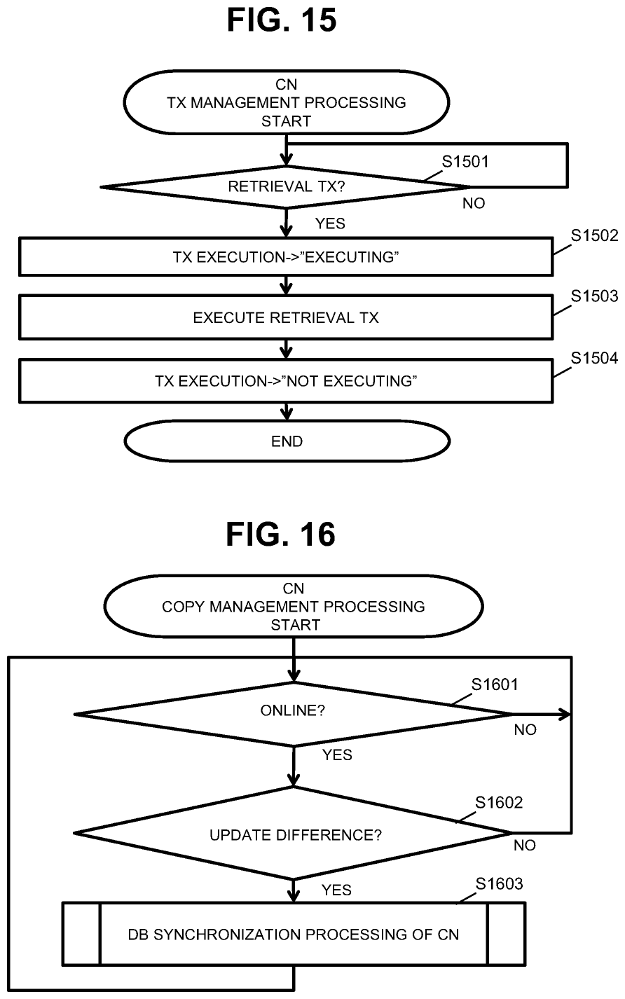

FIG. 15 illustrates a flow of the TX management processing of the CN 11C.

In the case of receiving allocation of the retrieval TX (S1501: YES), the TX management unit 31C changes the TX execution 423 corresponding to the CN 11C to “executing” (S1502). Thereafter, the query execution unit 32C executes the query in the allocated retrieval TX (S1503). Then, the TX management unit 31C changes the TX execution 423 corresponding to the CN 11C to “not executing” (S1504).

In FIG. 15, S1503 corresponds to S43 in FIG. 4.

FIG. 16 illustrates a flow of the copy management processing of the CN 11C.

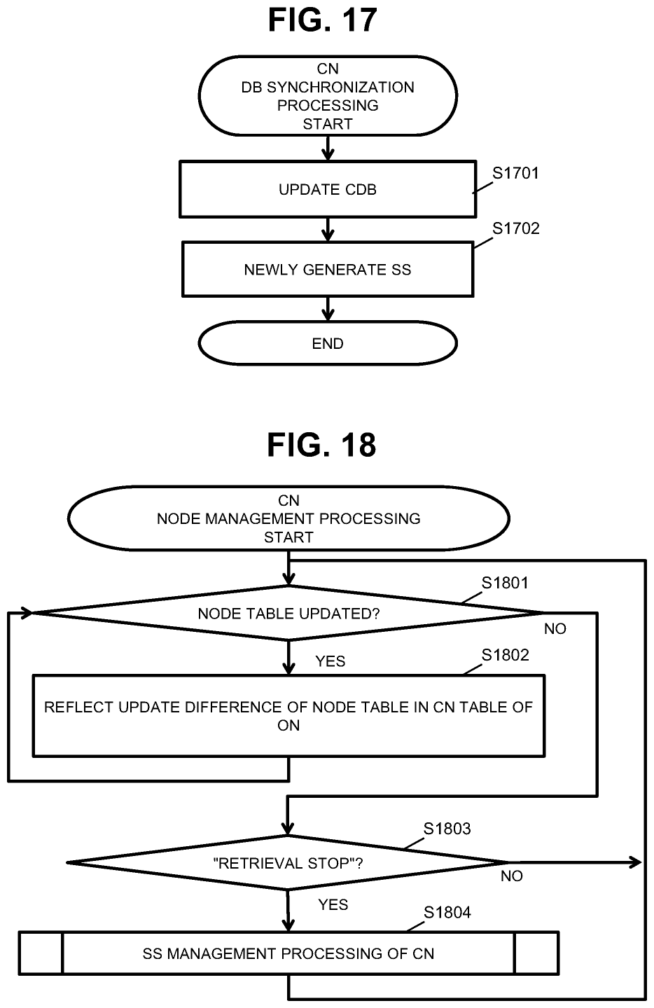

In the case of being in the online state (S1601: YES) and receiving the update difference from the copy unit 36M of the ON 11M (S1602: YES), the copy unit 36C performs the DB synchronization processing (FIG. 17) of the CN 11C (S1603).

Note that the copy unit 36C may be generally in the offline state and turned to the online state from the copy unit 36M that is a copy source (or may be periodically turned to the online state from the DB management unit 30C). Or, the copy unit 36C may be generally in the online state.

FIG. 17 illustrates a flow of the DB synchronization processing of the CN 11C.

The copy unit 36C reflects the received update difference in the CDB 13C of the CN 11C (S1701). In such a manner, the CDB 13C is updated. The copy unit 36C (or the DB synchronization management unit 34C) generates the SS of the CDB 13C after the update (S1702).

In FIG. 17, S1702 corresponds to S54 in FIG. 5.

FIG. 18 illustrates a flow of node management processing of the CN 11C.

The node management unit 35C determines whether or not the node table 26 of the CN 11C is updated (S1801). In the case that the determination result in S1801 is true (S1801: YES), the node management unit 35C reflects the update difference of the node table 26 in a corresponding part in the CN table 25 of the ON 11M (S1802).

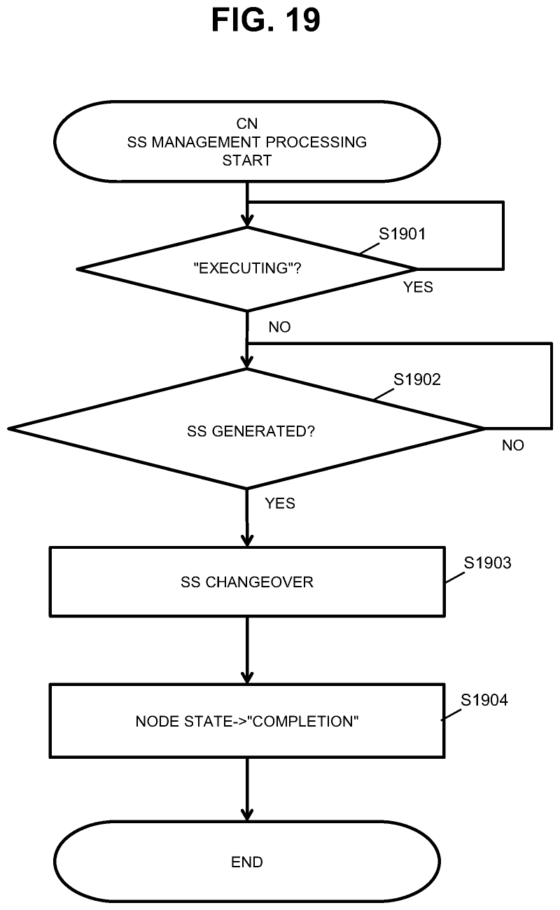

In the case that the determination result in S1801 is false (S1801: NO), the node management unit 35C determines whether or not the node state 422 of the CN is “retrieval stop” (S1803). In the case that the determination result in S1803 is true (S1803: YES), SS changeover processing (FIG. 19) is performed (S1804).

FIG. 19 illustrates a flow of SS management processing of the CN 11C.

The SS changeover management unit 33C determines whether or not the TX execution 423 of the CN 11C is “executing” (S1901). In the case that the determination result in S1901 is true (S1901: YES), the SS changeover management unit 33C stands by until the TX execution 423 is changed to “not executing”.

In the case that the determination result in S1901 is false (S1901: NO), the SS changeover management unit 33C determines whether or not the SS is newly generated in the DB synchronization processing illustrated in FIG. 17 (S1902). Note that determination on whether or not the SS is newly generated can be specified as follows for example. That is, when the SS is newly generated, the DB synchronization management unit 34C stores information indicating that the SS is newly generated (an ID of the newly generated SS or the like, for example) in the storage area managed by the CN 11C, and the SS changeover management unit 33C determines whether or not the SS is newly generated by referring to the information. More specifically, it is as follows for example. That is, the DB synchronization management unit 34C stores, in the storage area managed by the CN 11C, (X) the ID of the SS currently referred to by the CN 11C and (Y) the ID of the latest SS among the prepared SSes. When the SS is newly generated, the DB synchronization management unit 34C updates the information (Y) with the ID of the prepared SS. When the information (X) and the information (Y) are different, the SS changeover management unit 33C determines that the SS is newly generated.

In the case that the determination result in S1902 is true (S1902: YES), the SS changeover management unit 33C switches the reference destination of the CN 11C to the latest SS (S1903). Then, the SS changeover management unit 33C changes the node state 422 of the CN 11C to “completion” (S1904).

In FIG. 19, S1901: YES corresponds to S56 in FIGS. 6 and S61 in FIG. 9, S1903 corresponds to S57 in FIGS. 7 and S62 in FIGS. 9, and S1904 corresponds to S58 in FIGS. 7 and S63 in FIG. 9.

According to the description above, in each node 11, the DB management unit 30 and the copy unit 36 are linked. For example, in the ON 11M, the DB management unit 30M changes the copy unit 36M to the online state or turns the copy unit 36M back to the offline state. In addition, in each CN 11C, the copy unit 36M (or the DB synchronization management unit 34C) generates the SS (latest SS) of the CDB 13C after the update, and the DB management unit 30C switches the reference destination of the CN 11C to the latest SS. Thus, the DBMS which updates the DB using the copy unit 36 that performs copying between the storage areas where the DB 13 is stored can perform the consistent retrieval.

In addition, in the present embodiment, the copy unit 36M is generally in the offline state. When the update TX is executed while the copy unit 36M is kept in the online state, in order to complete the update TX, the update difference of the ODB 13M needs to be reflected in each of the CDBs 1-3, in addition to the update of the ODB 13M. Therefore, it takes time to complete the execution of the update TX. In the present embodiment, since the copy unit 36M is generally in the offline state, the time to complete the execution of the update TX can be shortened.

### Embodiment 2

The embodiment 2 will be described. At the time, differences from the embodiment 1 will be mainly described, and the description of common points with the embodiment 1 will be omitted or simplified.

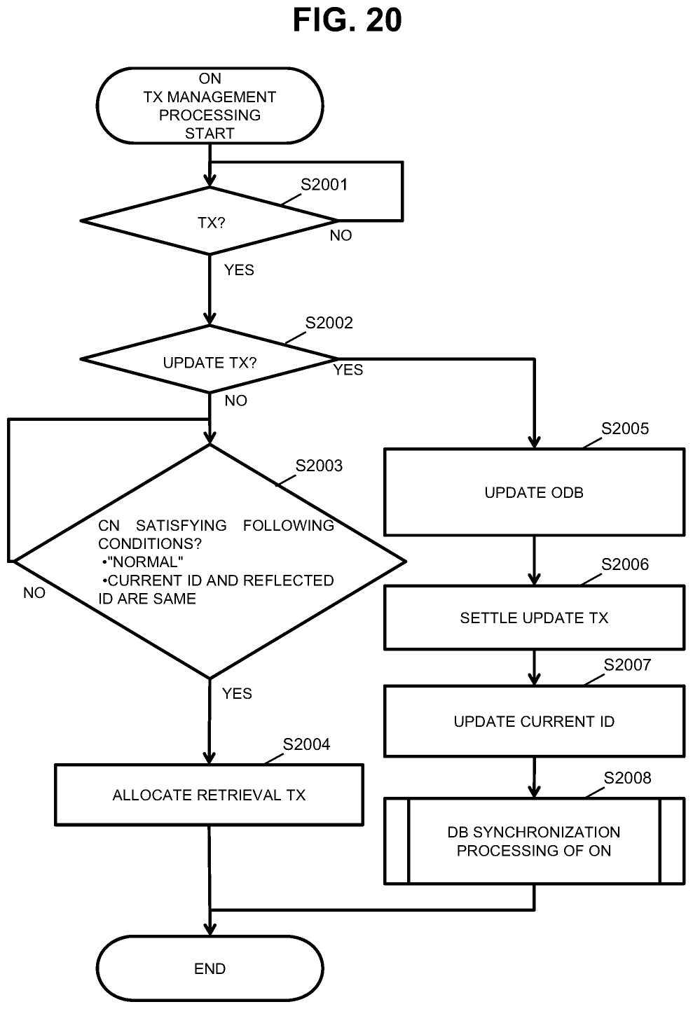

FIG. 20 illustrates a flow of the TX management processing of the ON 11M relating to the embodiment 2.

S2001, S2002 and S2005 are respectively the same as S1101, S1102 and S1104 illustrated in FIG. 11.

In the present embodiment, after S2005, the TX management unit 31M settles the update TX before the DB synchronization processing of the ON 11M (S2006).

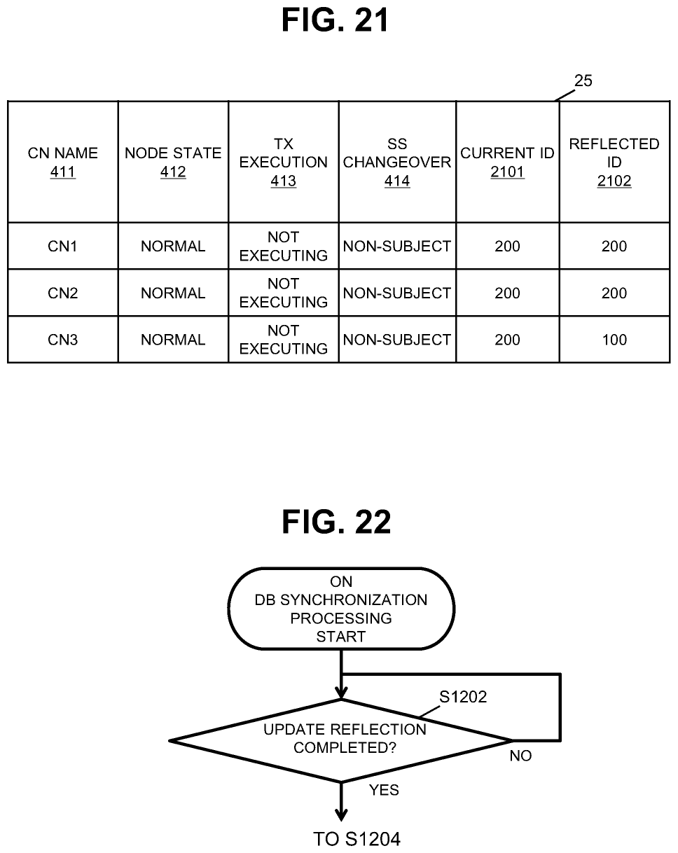

Then, in the present embodiment, as illustrated in FIG. 21, the CN table 25 holds information such as a current ID 2101 and a reflected ID 2102 for each CN 11C in addition to the pieces of information 411-414 described above (though not illustrated, each node table 26 also holds the information such as the current ID and the reflected ID in addition to the pieces of information 421-424 described above). For each CN 11C, the current ID 2101 indicates the ID of the latest update TX among the update TXes of the ODB 13M, and the reflected ID 2102 indicates the ID of the update TX corresponding to the latest update difference reflected in the CDB 13C among the update differences of the ODB 13M. Thus, in the case that the update difference generated by the latest update TX among the update TXes of the ODB 13M is already reflected in the CDB 13C, the reflected ID 2102 is the same as the current ID 2101. Every time the update TX is executed and settled and the update difference is generated, correspondence between the generated update difference and the ID of the update TX is managed by the ON 11M, and when the update difference is reflected in the CDB 13C, the ID of the update TX corresponding to the update difference may be notified to the CN 11C corresponding to the CDB 13C.

FIG. 20 is referred to. After S2006, the TX management unit 31M updates the current ID 2101 of each CN 11C to the ID of the update TX settled in S2006 (S2007). Thereafter, the DB synchronization processing of the ON 11M is performed (S2008). Note that, when the DB synchronization processing of the ON 11M is performed, the DB synchronization processing of the CN 11C is also performed. In the DB synchronization processing of the CN 11C, the update difference is reflected in the CDB 13C, and the SS of the CDB 13C after the update is newly generated. When the SS is generated, the reflected ID in the node table 26 of the CN 11C is updated to the ID of the update TX corresponding to the reflected update difference. The reflected ID after the update is reflected in the reflected ID 2102 of the CN table 25 from the node table 26.

In the case that the TX received by the TX management unit 31M is the retrieval TX (S2002: NO), the TX management unit 31M refers to the CN table 25, and determines whether or not there is the CN 11C satisfying the conditions described below (S2003).
The node state 412 is “normal”.
The reflected ID 2102 is the same as the current ID 2101.

In the case that the determination result in S2003 is false (S2003: NO), the TX management unit 31M stands by for the allocation of the retrieval TX until one of the CNs 11C satisfies the conditions described above (in other words, until the SS of the CDB 13C in which the latest update difference is reflected is generated and the SS is defined as the reference destination).

In the case that the determination result in S2003 is true (S2003: YES), the TX management unit 31M allocates the retrieval TX to the CN 11C satisfying the conditions described above (S2004).

In the present embodiment, as described above, after S2005, the update TX is settled before the DB synchronization processing of the ON 11M, and even in that case, the DBMS can perform the consistent retrieval.

### Embodiment 3

The embodiment 3 will be described. At the time, differences from the embodiments 1 and 2 will be mainly described, and the description of common points with the embodiments 1 and 2 will be omitted or simplified.

FIG. 22 illustrates a part of a flow of the DB synchronization processing of the ON 11M relating to the embodiment 3.

That is, in the present embodiment, the copy unit 36M is generally in the online state. Therefore, compared to the DB synchronization processing illustrated in FIGS. 12, S1201 and S1203 illustrated in FIG. 12 are not needed in the embodiment 3.

Although some embodiments are described above, the embodiments are illustrations to describe the present invention and are not for a purpose of limiting the scope of the present invention only to the embodiments. The present invention can be implemented also in various other forms.

We claim:

1. A database management system comprising:
a first node in a first computer; and
a second node in each of m second computers (m is an integer equal to or larger than 2),
wherein
the first node manages management information indicating a state of the second node for each of m second nodes provided respectively in the m second computers,
there is a normal state which is a state where a retrieval transaction can be received and a retrieval stop state which is a state where the retrieval transaction cannot be received as the state of the second node, for each second node, and
when the first node receives the retrieval transaction,
(R1) the first node allocates the received retrieval transaction to the second node in the normal state, and
(R2) the second node retrieves a snapshot defined as a reference destination for a second database corresponding to the second node among m second databases provided respectively in the m second computers and corresponding respectively to the m second nodes by executing the allocated retrieval transaction, and
when the first node receives an update transaction, the first node updates a first database provided in the first computer by executing the update transaction, and
when the first database is updated,
(U1) for each of the m second databases, the second computer including the second database and the first computer reflect an update difference generated by update of the first database in the second database in block units,
(U2) each of the m second computers generates, when the update difference is reflected in the second database corresponding to the second node, the snapshot of the second database after the update difference is reflected,
(U3) the first node changes the state indicated by the management information to the retrieval stop state for each of n (n is a natural number and n<m) second nodes,
(U4) each of the n second nodes, when the second node is not executing the retrieval transaction, switches the reference destination in the second node to the snapshot generated in (U2), and the first node changes the state indicated by the management information to the normal state for the second node, and
(U5) when the state indicated by the management information is changed to the normal state for each of the n second nodes, each of (m-n) second nodes switches the reference destination of the second node to the snapshot generated in (U2).

2. The database management system according to claim 1,
wherein,
in (U5), when the state indicated by the management information is changed to the normal state for each of the n second nodes,
the first node changes the state indicated by the management information to the retrieval stop state for each of the (m-n) second nodes, and
when the reference destination in the second node is switched to the snapshot generated in (U2) for each of the (m-n) second nodes, the first node changes the state indicated by the management information to the normal state for the second node.

3. The database management system according to claim 1,
wherein
there is a completion state which is a state where changeover of the snapshot of the second database is completed further as the state of the second node for each of the second nodes, and
in (U4), when the reference destination in the second node is switched to the snapshot generated in (U2) for each of the n second nodes,
the first node changes the state indicated by the management information to the completion state for the second node, and
when the state of a fixed number or more of second nodes among the n second nodes is the completion state, the first node changes the state indicated by the management information to the normal state for the fixed number or more of second nodes.

4. The database management system according to claim 1, wherein
the first node includes a first database management unit that controls a first copy unit in the first computer in execution of update transaction,
each of the m second nodes includes a second database management unit,
(R1) is performed by the first database management unit,
(R2) is performed by the second database management unit of the second node to which the retrieval transaction is allocated,
in (U1), the update difference generated by the update of the first database is reflected in the second database in block units for each of the m second databases by at least one of the first copy unit and a second copy unit in the second computer including the second database,
(U2) is performed by the second copy unit or the second node of each of the n second computers,
(U3) is performed by the first database management unit,
in (U4), the reference destination is switched by the second database management unit of the second node and the state is changed by the first database management unit for each of the n second nodes, and
in (U5), the reference destination is switched by the second database management unit of the second node for each of the n second nodes.

5. The database management system according to claim 4,
wherein
(U1) and (U2) are performed by the first database management unit changing the state of the first copy unit from an offline state to an online state, and
when (U1) and (U2) are completed, the first database management unit turns back the state of the first copy unit from the online state to the offline state, and performs (U3) thereafter.

6. The database management system according to claim 1,
wherein the first node executes the update transaction but does not execute the retrieval transaction.

7. The database management system according to claim 1,
wherein,
when the first database is updated, the first node settles the update transaction and manages an ID of the update transaction as a current update transaction ID, (U1) to (U5) are performed thereafter, and
when the second node generates the snapshot of the second database after the update difference is reflected for each of the m second nodes in (U2) of (U1) to (U5), the first node changes the update transaction ID reflected in the second node to the current update transaction ID, and
when the first node receives the retrieval transaction,
in a case where there is the second node satisfying a condition that the state is the normal state and the reflected update transaction ID is same as the current update transaction ID, the first node allocates the retrieval transaction to the second node in (R1), and
in the case that there is not the second node satisfying the condition, the first node stands by for allocation of the retrieval transaction until the second node satisfying the condition appears.

8. A database management method performed by a database management system including a first node in a first computer and a second node in each of m second computers (m is an integer equal to or larger than 2),
wherein,
when the first node receives a retrieval transaction,
the first node allocates the received retrieval transaction to the second node in a normal state which is a state where the retrieval transaction can be received,
the second node retrieves a snapshot defined as a reference destination for a second database corresponding to the second node among m second databases provided respectively in the m second computers and corresponding respectively to the m second nodes by executing the allocated retrieval transaction, and
when the first node receives an update transaction, the first node updates a first database provided in the first computer by executing the update transaction, and
when the first database is updated, for each of the m second databases, an update difference generated by update of the first database is reflected in the second database in block units, and the snapshot of the second database after the update difference is reflected is generated,
the first node changes the state of the second node to a retrieval stop state which is a state where the retrieval transaction cannot be received for each of n (n is a natural number and n<m) second nodes,
each of the n second nodes switches, when the second node is not executing the retrieval transaction, the reference destination in the second node to the generated snapshot, and the first node changes the state of the second node to the normal state, and
when the state of the second node is changed to the normal state for each of the n second nodes, each of (m-n) second nodes switches the reference destination of the second node to the generated snapshot.
